(19) United States
(12) Patent Application Publication
(10) Pub. No.: US 2025/0323302 A1
(43) Pub. Date: Oct. 16, 2025

(54) FUEL CELL ANODE DESIGN FOR MITIGATED START-UP/SHUT-DOWN CORROSION RESISTANCE

(71) Applicant: GM Global Technology Operations LLC, Detroit, MI (US)

(72) Inventors: Nagappan Ramaswamy, Rochester Hills, MI (US); Swaminatha P. Kumaraguru, Rochester Hills, MI (US)

(73) Assignee: GM Global Technology Operations LLC, Detroit, MI (US)

(21) Appl. No.: 18/631,957

(22) Filed: Apr. 10, 2024

(51) Int. Cl. H01M 8/1004; H01M 4/86; H01M 4/92; H01M 8/10

(52) U.S. Cl. CPC H01M 8/1004; H01M 4/8668; H01M 4/926; H01M 2004/8684; H01M 2008/1095; H01M 2250/20

(57) ABSTRACT

A membrane electrode assembly includes a cathode disposed on one end and an anode disposed on an opposite end from the cathode. The membrane electrode assembly also includes a proton exchange membrane disposed between the cathode and the anode. Additionally, the anode further includes at least one catalyst layer including a catalyst active material, carbon support material, at least one ionomer, and polymelamine formaldehyde polymer as an additive.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to a membrane electrode assembly and, more specifically, to a fuel cell including a membrane electrode assembly with an anode electrode including nitrogen containing polymers.

Fuel cells are clean energy conversion devices that generate electrical power when fueled with pure hydrogen gas on an anode and oxygen gas from atmospheric air as an oxidant on a cathode, where the only by-products are heat and water, making fuel cells a sustainable power source. The anode and the cathode electrodes are disposed on either side of a proton conducting membrane to form the membrane electrode assembly. Ideally, the anode is active only for a hydrogen oxidation reaction while the cathode is expected to be active only for an oxygen reduction reaction.

While fuel cells are a source of clean energy, during fuel cell start-up and/or shut-down operations, the anode becomes contaminated with oxygen from atmospheric air such that there is a combined hydrogen/oxygen gaseous front in the anode electrode. This creates a local electrolytic cell phenomenon where the hydrogen gets oxidized and simultaneously the oxygen gets reduced at spatially different locations within the anode. This involves hydrogen oxidation on the anode to protons and electrons. While the protons are transported to the cathode via the proton exchange membrane, the electrons are consumed within the anode in a short-circuit fashion by the oxygen, which gets reduced to water. This drives the cathode voltage potential higher, such as to values of greater than 1.0 V. Increased cathode potential can lead to undesirable electrode carbon corrosion within the fuel cell. As such, decreasing the anode's activity for oxygen reduction reaction and enhancing the anode's selectivity for only hydrogen oxidation reaction is critical to prevent cathode carbon corrosion during fuel cell start-up and/or shut-down operation.

### SUMMARY

In one configuration, a membrane electrode assembly includes a cathode disposed on one end and an anode disposed on an opposite end from the cathode. The membrane electrode assembly also includes a proton exchange membrane disposed between the cathode and the anode. Additionally, the anode further includes at least one catalyst layer including a catalyst active material, carbon support material, at least one ionomer, and polymelamine formaldehyde.

The membrane electrode assembly may also include an anode with one or more of the following optional features. For example, a weight ratio of polymelamine formaldehyde to carbon may be about 0.05 to about 0.2. Additionally, a weight ratio of polymelamine formaldehyde to carbon may be about 0.05 to about 0.15. Moreover, a weight ratio of polymelamine formaldehyde to carbon may be about 0.1. Additionally, the catalyst active material may be one of Platinum or Palladium. Moreover, the ionomer may be perfluorosulfonic acid. Additionally, a fuel cell may incorporate the membrane electrode assembly. Moreover, a vehicle may incorporate the fuel cell.

In another configuration a membrane electrode assembly includes a cathode electrode disposed on one end and an anode electrode disposed on an opposite end from the cathode. The anode electrode or anode catalyst layer includes a catalyst active material, carbon support, at least one ionomer, and polymelamine formaldehyde. Further, the membrane electrode assembly also includes a proton exchange membrane disposed between the cathode and the anode.

The membrane electrode assembly may also include one or more of the following optional features. For example, the anode electrode or anode catalyst layer may be homogeneously dispersed. Additionally, a weight ratio of polymelamine formaldehyde to carbon may be about 0.05 to about 0.2. Moreover, a weight ratio of polymelamine formaldehyde to carbon may be about 0.1. Additionally, the catalyst active material may be one of Platinum or Palladium. Further, the ionomer may be perfluorosulfonic acid.

In yet another configuration, a membrane electrode assembly includes an electrode including a substrate and a catalyst ink disposed on the substrate. Additionally, the catalyst ink includes a platinum on carbon catalyst, a perfluoro sulfonic acid ionomer; and a polymelamine formaldehyde additive.

The membrane electrode assembly may also include one or more of the following optional features. For example, an anode electrode with a weight ratio of polymelamine formaldehyde to carbon may be about 0.05 to about 0.2. Additionally, a weight ratio of polymelamine formaldehyde to carbon may be about 0.05 to about 0.15. Moreover, a weight ratio of polymelamine formaldehyde to carbon may be about 0.1. Additionally, a fuel cell may incorporate the membrane electrode assembly.

### BRIEF DESCRIPTION OF THE DRAWINGS

The drawings described herein are for illustrative purposes only of selected configurations and are not intended to limit the scope of the present disclosure.

FIG. 1 is a perspective view of a vehicle including a fuel cell incorporating a membrane electrode assembly according to the present disclosure;

FIG. 2A is schematic view of a start-up/shut down mechanism of the membrane electrode assembly according to the present disclosure;

FIG. 2B is a schematic view of a fuel cell incorporating the membrane electrode assembly according to the present disclosure;

FIG. 3 is schematic view of ionomers disposed within the membrane electrode assembly according to the present disclosure;

FIG. 4A is a graphic illustration of a hydrogen oxidation reaction (HOR)/hydrogen evolution reaction (HER) of various membrane electrode assemblies including varying amounts of nitrogen containing polymers disposed within the membrane electrode assembly according to the present disclosure; and

FIG. 4B is a graphic illustration of an oxygen reduction reaction of various membrane electrode assemblies including varying amounts of nitrogen containing polymers disposed within the membrane electrode assembly according to the present disclosure.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

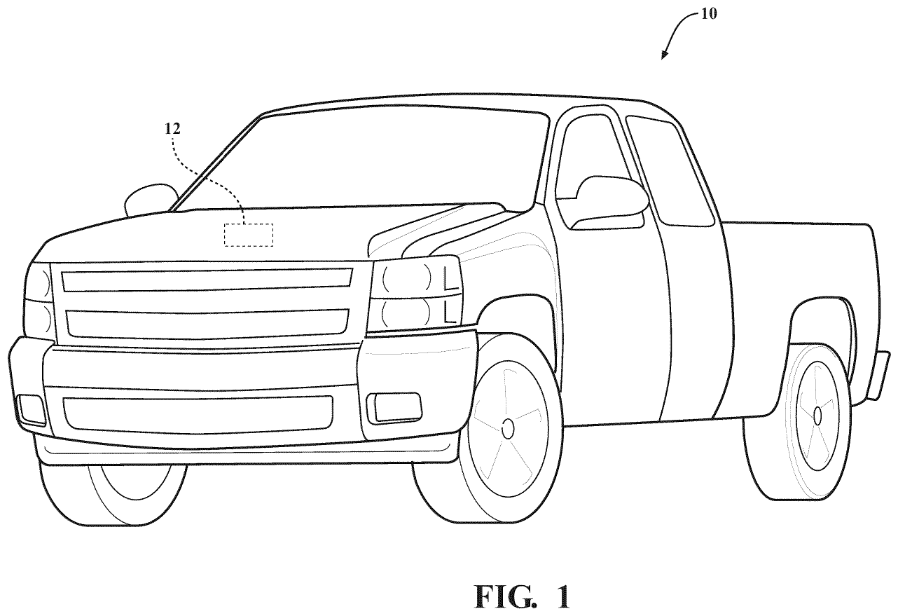

Referring to FIGS. 1-4, a fuel cell 12 is disclosed. The fuel cell 12 is configured to generate electric current from hydrogen and oxygen gases through a pair of electrochemical redox reactions. Additionally, the fuel cell 12 may be incorporated into devices that require energy such as an appliance or a vehicle 10, as shown in FIG. 1. When the fuel cell 12 is incorporated into the vehicle 10, the vehicle 10 maybe an electric vehicle 10 (EV) and may include autonomous or semi-autonomous capabilities. Alternatively, the vehicle 10 may be a hybrid vehicle 10 incorporating both EV and internal combustion engine (ICE) components and capabilities. The vehicle 10 also includes the fuel cell 12 configured to provide power to the vehicle 10. More specifically, vehicles 10 including the fuel cell 12 are powered by compressed hydrogen gas that feeds into an onboard fuel cell 12 stack that doesn't burn the gas, but instead transforms the gas's chemical energy into electrical energy to power an electric motor to power the vehicle 10.

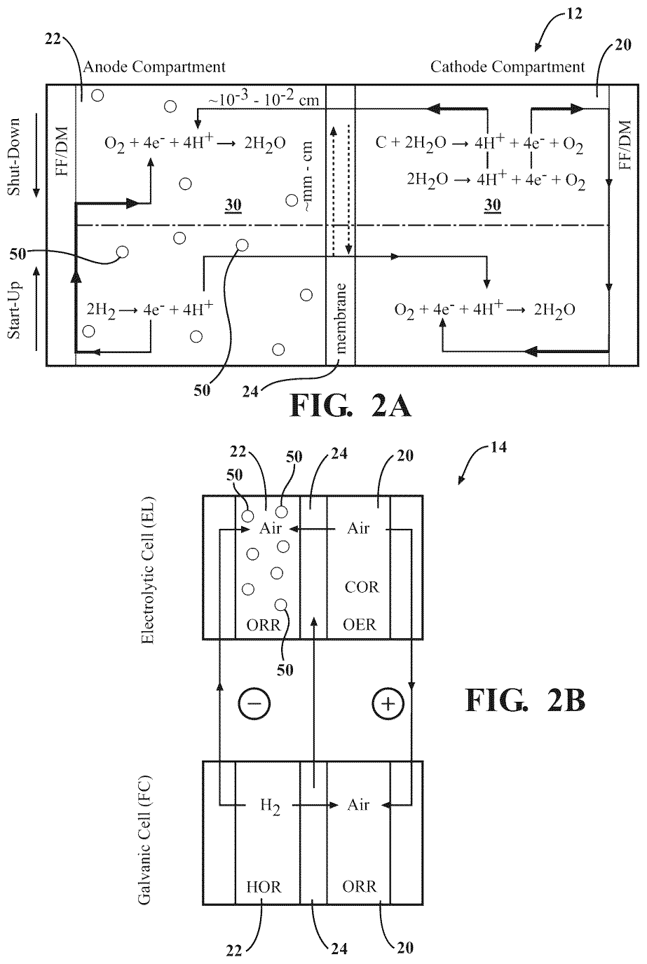

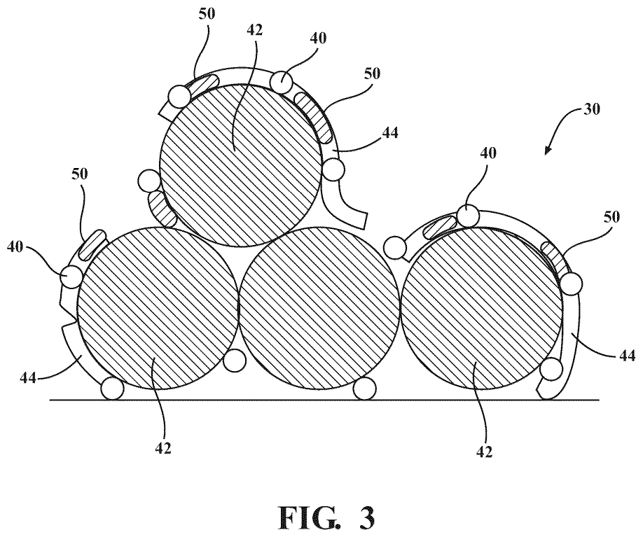

As best shown in FIG. 2, the membrane electrode assembly 100 which is incorporated in the fuel cell 12, includes a cathode 20 disposed on one end and an anode 22 disposed on an opposite end from the cathode 20. The cathode 20 includes a positively charged porous electrode by which electrons enter the membrane electrode assembly 100 and within which oxygen reduction reaction occurs (i.e., a chemical reaction that yields water). Additionally, the anode 22 includes a negatively charged porous electrode within which the hydrogen oxidation reaction takes place to generate protons and electrons, and by which the electrons leave the membrane electrode assembly 100.

Referring still to the example shown in FIG. 2, the proton exchange membrane 24 is disposed between the cathode 20 and the anode 22. Generally, the proton exchange membrane 24 may be comprised of a fluoropolymer proton permeable electrical insulator barrier. Alternatively, the proton exchange membrane 24 may be a hydrocarbon proton permeable electrical insulator barrier. Further, the proton exchange membrane 24 serves as a conductor for protons generated at the anode 22 to transport to the cathode 20 as a reactant for the oxygen reduction reaction.

Additionally, one or more of the cathode 20 or the anode 22 also includes at least one catalyst layer 30. The catalyst layer 30 includes at least a catalyst active material 40, support material 42, and an ionomer 44. The catalyst active material 40 is configured to split gaseous hydrogen molecules to protons and electrons in the anode electrode. Additionally, the catalyst active material 40 may be supported nanoparticles. Further, the anode catalyst active materials 40 may include, but are not limited to, nanoparticles of Platinum, Palladium, Copper, Gold, Ruthenium, Silver, Cobalt, Iridium and/or Nickel. Additionally, the catalyst active material 40 may be in powder or solid form.

As best shown in FIG. 3, due to their size, the catalyst active material 40 may be supported within the catalyst layer 30. More specifically, the catalyst active material 40 may be supported by the support material 42. Additionally, the support material 42 may be one or more of carbon, an oxide, charcoal, or a zeolite. Further, the support material 42 may include, but is not limited to, carbon black, one-dimensional forms of carbon, any allotropes of carbon, and/or metal oxides.

Additionally, the ionomer 44 acts both as a proton conducting agent and a binder to hold the supported catalyst active material 40 together on the electrode of the cathode 20 and/or the anode 22. More specifically, the ionomer 44 may consist of repeating units of electrically neutral and ionized groups bonded to a polymer backbone. For example, the ionomer 44 may be perfluorosulfonic acid or other perfluorinated and/or polyfluorinated alkyl compounds.

During start-up and shut-down of the fuel cell 12, atmospheric air or oxygen is entrained in the anode compartment as a contaminant. This causes a hydrogen/air gaseous mix, or a front, within the anode 22 leading to a local electrolytic cell phenomenon, i.e. by which chemical energy from a chemical reaction is converted to electrical energy. The formation of the hydrogen and ambient air mixture causes the oxygen reduction reaction to occur in the anode electrode which raises the potential of the opposite cathode electrode to a point where carbon corrosion takes place, e.g. >1 V. As such, to prevent the oxygen reduction reaction on the anode electrode, the electrode may be modified with nitrogen containing polymers 50 that preferentially adsorb on the anode catalyst active material 40 thereby rendering it less active for the oxygen reduction reaction without compromising its hydrogen oxidation reaction activity. For example, the nitrogen containing polymers 50 may include, but are not limited to polymelamine formaldehyde (PMF), melamine, or urea formaldehyde etc.

Additionally, the nitrogen containing polymers 50, such as polymelamine formaldehyde, may be present in the catalyst layer 30 of the electrode in the anode 22. Additionally or alternatively, the nitrogen containing polymers 50 may be present within the electrode itself (e.g. anode 22). More specifically, the electrode (e.g. anode 22) may be fabricated from a catalyst ink which includes the nitrogen containing polymers 50. Further, the catalyst ink may be formed by mixing the components of the electrode in a solution and then drying the solution. For example, the catalyst active material 40, the ionomers 44, the support material 42, and the nitrogen containing polymers 50 may be formed as a solution along with water which is then dried to form the electrode.

Moreover, a weight ratio of polymelamine formaldehyde to carbon is about 0.05 to about 0.2. In another example, the weight ratio of polymelamine formaldehyde to carbon is about 0.05 to about 0.15. In yet another example, the weight ratio of polymelamine formaldehyde to carbon is about 0.07 to about 0.12. In yet another example, the weight ratio of polymelamine formaldehyde to carbon is about 0.1.

### Example

The following example is illustrative of exemplary configurations of the disclosure. In these examples, as well as elsewhere in this application, all ratios, parts, and percentages are by weight unless otherwise indicated. It is intended that these examples are being presented for the purpose of illustration only and are not intended to limit the scope of the disclosure.

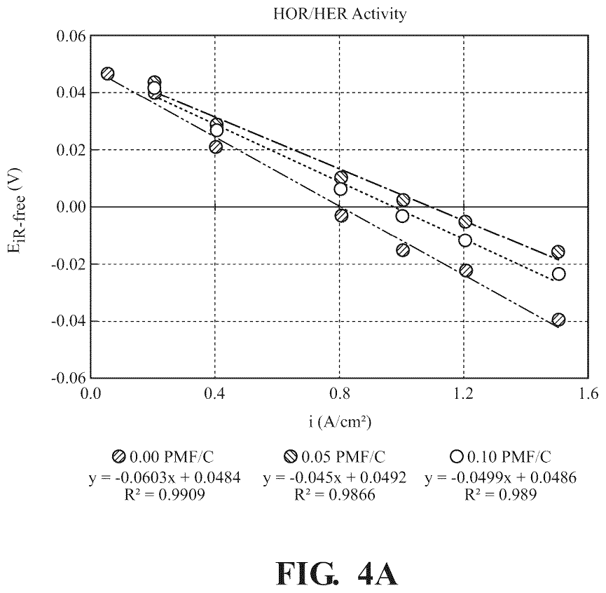

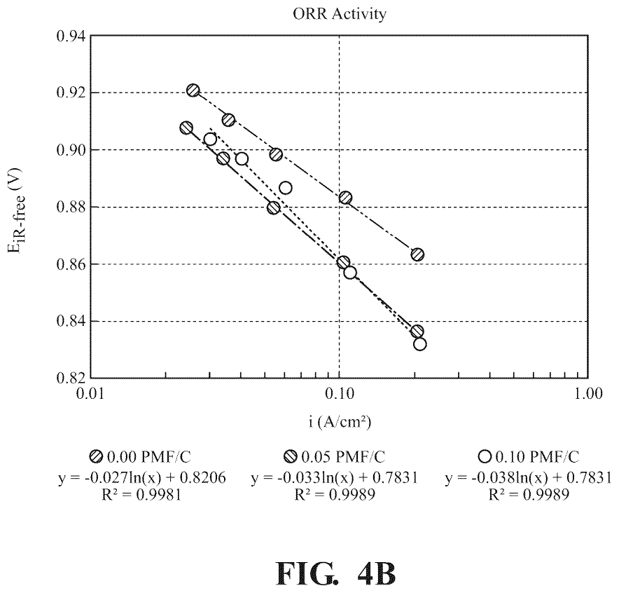

The examples shown in FIGS. 4A and 4B provide graphic illustrations of both the hydrogen oxidation reaction (HOR)/hydrogen evolution reaction (HER) and the oxygen reduction reaction (ORR) of various membrane electrode assemblies including varying amounts of nitrogen containing polymers 50 disposed within the membrane electrode assembly 100 according to the present disclosure. The current state of the art fuel cell electrodes which do not include a nitrogen containing polymer are composed of platinum nanoparticles supported on carbon supports dispersed in the electrode along with perfluoro sulfonic acid (PFSA) ionomer for proton conduction. The platinum loading is less than or equal to 0.1 mg (Pt)/cm² and the ionomer loading is 0.4 to 1.2 ionomer to anode 22 carbon ratio.

In the membrane electrode assemblies 100 described herein, the anode catalyst layer 30 is modified by treating a diluted aqueous solution of polymelamine formaldehyde followed by filtration and drying. The anode catalyst layer 30 is then a homogeneously dispersed catalyst layer composed of carbon supported platinum catalyst and PFSA ionomer along with a specified polymelamine formaldehyde to carbon weight ratio.

In FIG. 4A, three membrane electrode assemblies having varying amounts of polymelamine formaldehyde dispersed therein were tested during start-up and shut-down procedures. More specifically, each membrane electrode assembly 100, having no polymelamine formaldehyde, having a 0.05 polymelamine formaldehyde to carbon ratio, and having a 0.10 polymelamine formaldehyde to carbon ratio, was tested for its HOR/HER activity to measure voltage as a function of electric current density of the membrane electrode assembly 100. As shown in FIG. 4A, during the hydrogen oxidation reaction, the two membrane electrode assemblies which include the polymelamine formaldehyde have an increased voltage as a function of electric current density compared to the membrane electrode assembly 100 which does not include the nitrogen containing polymer 50.

Additionally, in FIG. 4B, three membrane electrode assemblies having varying amounts of polymelamine formaldehyde dispersed in the anode therein were tested for its oxygen reduction reaction activity on the anode. As shown, during the oxygen reduction reaction, the two membrane electrode assemblies which include the polymelamine formaldehyde have a decreased voltage as a function of the electric current density compared to the membrane electrode assembly 100 which does not include the nitrogen containing polymer 50 indicating the polymelamine formaldehyde containing membrane electrode assemblies at least partially prevent the oxygen reduction reaction on the anode electrode. This proves that the polymelamine formaldehyde inhibits oxygen reduction reaction in the anode while maintaining or improving hydrogen oxidation reaction. This is critical to mitigate the cathode carbon corrosion during fuel cell membrane electrode assembly start-up/shut-down operation.

As such, the membrane electrode assembly 100 as described herein includes polymeric additives such as polymelamine formaldehyde or melamine that adsorbs on the surface of the anode catalyst layer 30 to render the anode catalyst layer 30 less active for the oxygen reduction reaction without compromising hydrogen oxidation reaction activity. Decreasing the activity of the anode catalyst layer 30 for oxygen reduction reaction leads to decreased potential on the cathode which decreases the amount of carbon corrosion of the cathode electrodes during start up and/or shut down procedures.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A fuel cell membrane electrode assembly comprising:
a cathode disposed on one end and including a positively charged porous electrode by which electrons enter the membrane electrode assembly and within which oxygen reduction reaction occurs;
an anode disposed on an opposite end from the cathode and including a negatively charged porous electrode within which a hydrogen oxidation reaction takes place to generate protons and electrons, and by which the electrons leave the membrane electrode assembly; and
a proton exchange membrane disposed between the cathode and the anode,
wherein the anode further includes at least one catalyst layer including:
a catalyst active material;
carbon support including one or more of carbon black, one-dimensional forms of carbon, or allotropes of carbon;
at least one ionomer having repeating units of electrically neutral and ionized groups bonded to a polymer backbone; and
polymelamine formaldehyde.

2. The membrane electrode assembly of claim 1, wherein a weight ratio of polymelamine formaldehyde to carbon is about 0.05 to about 0.2 in the anode catalyst layer.

3. The membrane electrode assembly of claim 1, wherein a weight ratio of polymelamine formaldehyde to carbon is about 0.05 to about 0.15 in the anode catalyst layer.

4. The membrane electrode assembly of claim 1, wherein a weight ratio of polymelamine formaldehyde to carbon is about 0.1 in the anode catalyst layer.

5. The membrane electrode assembly of claim 1, wherein the anode includes melamine or urea formaldehyde instead of polymelamine formaldehyde within the anode catalyst layer.

6. The membrane electrode assembly of claim 1, wherein the catalyst active material is one of Platinum or Palladium.

7. The membrane electrode assembly of claim 1, wherein the ionomer is perfluorosulfonic acid.

8. A fuel cell incorporating the membrane electrode assembly of claim 1.

9. A vehicle incorporating the fuel cell of claim 8.

10. A membrane electrode assembly comprising:
a cathode disposed on one end;
an anode disposed on an opposite end from the cathode and having at least one catalyst layer including:
a catalyst active material,
carbon support,
at least one ionomer, and
one of polymelamine formaldehyde or melamine; and
a proton exchange membrane disposed between the cathode and the anode.

11. The membrane electrode assembly of claim 10, wherein the catalyst layer is homogeneously dispersed.

12. The membrane electrode assembly of claim 10, wherein a weight ratio of polymelamine formaldehyde to carbon is about 0.05 to about 0.2 in the anode catalyst layer.

13. The membrane electrode assembly of claim 10, wherein a weight ratio of polymelamine formaldehyde to carbon is about 0.1 in the anode catalyst layer.

14. The membrane electrode assembly of claim 10, wherein the anode catalyst active material is one of Platinum or Palladium.

15. The membrane electrode assembly of claim 10, wherein the ionomer is perfluorosulfonic acid.

16. A membrane electrode assembly comprising:
an anode electrode including a substrate and an anode catalyst ink disposed on the substrate to form the anode catalyst layer, wherein the catalyst ink includes:
platinum on carbon catalyst;
perfluoro sulfonic acid ionomer; and
polymelamine formaldehyde additive.

17. The membrane electrode assembly of claim 16, wherein a weight ratio of polymelamine formaldehyde to carbon in the anode catalyst layer is about 0.05 to about 0.2.

18. The membrane electrode assembly of claim 16, wherein a weight ratio of polymelamine formaldehyde to carbon in the anode catalyst layer is about 0.05 to about 0.15.

19. The membrane electrode assembly of claim 16, wherein a weight ratio of polymelamine formaldehyde to carbon in anode catalyst layer is about 0.1.

20. A fuel cell incorporating the membrane electrode assembly of claim 16.
